(19) United States
(12) Patent Application Publication
(10) Pub. No.: US 2009/0173921 A1
(43) Pub. Date: Jul. 9, 2009

(54) Conductive heating by encapsulated strontium source (Chess)

(76) Inventors: Ioan G. Crihan, New York, NY (US); Geoffrey G. Woods, Fairfield, CT (US); Jerrold E. Hyams, New York, NY (US)

Correspondence Address: IOAN G. CRIHAN, 417 E 64th St. # 4G, New York, NY, 10021, US

(21) Appl. No.: 12/078,669

(22) Filed: Apr. 3, 2008

Related U.S. Application Data
(60) Provisional application No. 60/845,160, filed on Jan. 9, 2008.

(51) Int. Cl. G21G 4/00

(52) U.S. Cl. 252/644

(57) ABSTRACT

The present invention deals with the encapsulation of a nuclear source of energy (Strontium 90) in order to generate up to 600 degree Celsius. The encapsulated Strontium 90 is destined to be used to generate steam, or to liquefy the viscous oil of wells, as well as the paraffin, covering the cables used in the extraction of oil, which makes the extraction difficult or impossible. The encapsulated Strontium 90 has to be transported into a metal housing already patented by Ioan G. Crihan, one of the undersigned authors (FIG. 1).

### CROSS REFERENCE TO RELATED APPLICATIONS

This application claims the benefit of U.S. Provisional Application No. 60/845,160, filed Jan. 9, 2008.

Strontium sources, which could generate 100 degree Celsius temperature, are combined, according to necessitates, to obtain up to 600 degree Celsius temperature. These sources are encapsulated in a metallic spherical structure or in a metallic vertical tube. The encapsulated sources are then installed and transported in a metal housing (FIG. 1) already patented by Ioan G. Crihan, one of the undersigned authors (U.S. Pat. No. 6,455,013 of 2002). The metallic housing has been adapted to prevent any nuclear or thermal radiations from leaking out.

This invention is designed with application, among others, hi the petroleum extraction industry, using the radioisotope heat technology to liquefy the oil wells, to clean the paraffin off the cables used hi the petroleum extraction industry, and to generate steam for different use.

The invention described herein puts a premium on the idea of mobility of the radioactive source and also on the variety of its temperature. No other industrial application or patented technology can accomplish this purpose because no one rely on the transportation of the radioisotope heat sources in the metal housing as this invention emphasizes.

### BRIEF DESCRIPTION OF THE DRAWINGS

FIG. 1 shows a side plan view of a transportable trailer having a drawing tractor.

### DESCRIPTION OF THE DRAWING

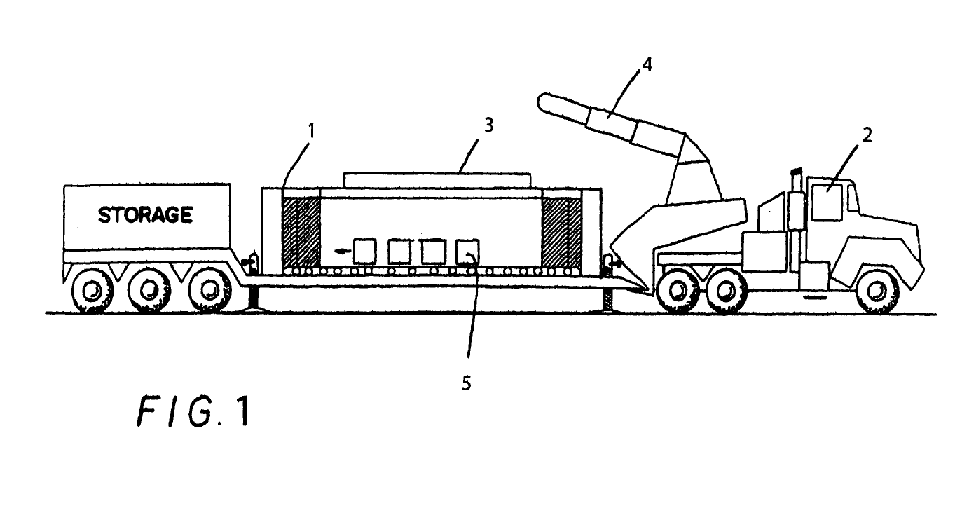

FIG. 1 shows of transportable trailer 1 having a drawing tractor 2 for bringing the irradiation chamber which is suitably housed in a clad housing to a processing site. The trailer has a removable protective roof 3 which may be removed by crane 4 in order to load or unload the radioisotope source 3 (Strontium 90). The radioisotope source is kept in locked containers 5 inside the trailer during the transportation.

1. The encapsulation of Strontium 90 sources in individual units which could generate temperature of 100 degree Celsius

2. The combination of encapsulated Strontium 90 sources able to generate 100 degree Celsius each in order to obtain, according to necessities, up to 600 degrees Celsius.

3. The encapsulation of Strontium 90 as in claim 1 (one unit) and claim 2 (up to 6 units) in a metallic spherical structure or in a metallic vertical tube.

4. The installation of the encapsulated Strontium 90 sources into a metal housing (FIG. 1) to be transported at the place of their use.
